(19) United States
(12) Patent Application Publication
(10) Pub. No.: US 2009/0196360 A1
(43) Pub. Date: Aug. 6, 2009

(54) LATTICE-REDUCTION-AIDED MIMO DETECTORS

(75) Inventors: Ying Hung Gan, Hong Kong (CN); Wai Ho Mow, Hong Kong (CN)

Correspondence Address: TUROCY & WATSON, LLP, 127 Public Square, 57th Floor, Key Tower, CLEVELAND, OH, 44114, US

(73) Assignee: THE HONG KONG UNIVERSITY OF SCIENCE AND TECHNOLOGY, Hong Kong (CN)

(21) Appl. No.: 12/023,494

(22) Filed: Jan. 31, 2008

(51) Int. Cl. H04L 27/28

(52) U.S. Cl. 375/260

(57) ABSTRACT

A Lenstra-Lenstra-Lovász (LLL)-based technique is utilized to reduce the complexity of a MIMO detector. Basis vectors can be pre-sorted, such as by V-BLAST ordering or sorted-QR ordering, prior to applying Gram-Schmidt Orthogonalization (GSO) to further improve performance. Alternatively, a joint sorting and LLL reduction (JSAR) technique can be utilized such that after each reduction step, a vector remaining to be reduced can be selected that will minimize the overall complexity. The JSAR technique can be applied on real or complex lattice bases. LLL reduction can be stopped after a predetermined threshold is exceeded.

### TECHNICAL FIELD

The subject disclosure relates generally to wireless communications systems, and more particularly to signal detection in multiple-input multiple-output (MIMO) systems.

### BACKGROUND OF THE INVENTION

Wireless communication networks are increasingly popular and widely deployed. Multiple-input multiple-output (MIMO) technology is a promising candidate for next-generation wireless communications. However, signal detection and decoding is more complex in MIMO networks than in conventional wireless networks that have only a single receive/transmit antenna per attached device.

The linearity of a communication channel and the lattice structure of a modulation scheme can be exploited to state many signal detection problems as a problem of finding a nearest lattice point. Further, the relative degree of freedom provided by such lattice-based approaches in choosing a lattice basis can be a significant factor affecting the quality and efficiency of such approaches. For example, conventional low-complexity and highly sub-optimal MIMO detectors can be modified to provide detection that achieves full diversity without a significant sacrifice in complexity by employing lattice reduction of associated MIMO channel matrices.

However, the process of finding a good lattice basis reduction can be significantly complicated in many conventional lattice-based signal detection approaches as compared to other components of such approaches, such that the lattice reduction complexity of conventional lattice-based signal detection techniques often dominates the overall detection complexity. Moreover, this disparity in complexity generally becomes more significant as the dimension of the associated communication system increases. As a result, difficulties arise in applying conventional signal detection techniques in many communication systems, such as those where an associated channel matrix or related lattice basis undergo frequent changes.

The above-described deficiencies of wireless network communications are merely intended to provide an overview of some of the problems of today's wireless networks, and are not intended to be exhaustive. Other problems with the state of the art may become further apparent upon review of the description of various non-limiting embodiments that follows.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

According to one aspect, a method and system of signal detection in MIMO networks is provided. A channel matrix is determined corresponding to a channel. After determining the channel matrix, the various basis vectors of the channel matrix can be sorted before performing the Gram-Schmidt Orthogonalization (GSO) step of Lenstra-Lenstra-Lovasz (LLL) lattice reduction technique. The sorting can be done, for example, using Vertical Bell Labs Layered Space-Time (V-BLAST) or sorted-QR ordering. Subsequently, an extended LLL technique that works with complex vectors can be used to reduce the sorted lattice. The resulting solution can then be used to decode the symbols sent over the channel.

In another embodiment, instead of pre-sorting the basis vectors prior to the GSO step, the sorting is performed jointly with reductions. After each reduction step of the LLL lattice reduction technique, a candidate vector can be selected that will reduce the overall complexity. This technique called, joint sorting and LLL reduction (JSAR), can be applied to the LLL reduction of real or complex lattice bases. The selection can be based, for example, on the vector with the shortest projection.

Since LLL lattice reduction is an iterative algorithm, the LLL can be stopped before continuing to another iteration when predetermined conditions occur. For example, the LLL can be stopped if a predetermined number of vectors have been swapped or the processing time has exceeded some predetermined threshold. Although stopping early prevents an ultimate reduced lattice solution from being determined, it can reduce complexity and the time needed to accurately detect the transmitted symbols.

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a diagram of an exemplary multiple-input multiple-output (MIMO) wireless communication network in which the aspects can be implemented.

FIG. 2 is a diagram of decoding received wireless data according to one aspect.

FIG. 3 is a graph of the bit error rate (BER) performance of various MIMO detectors without any sorting.

FIG. 4 is a graph of the BER performance of various MIMO detectors with sorting.

FIG. 5 is a graph of the BER performance of various MIMO detectors when the number of basis vectors being swapped is limited.

FIG. 6 is a block diagram of a lattice reduction component according to one embodiment.

FIG. 7 is a block diagram of a lattice reduction component according to another embodiment.

FIG. 8 is a flowchart of a method of an LLL reduction with naïve sorting in accordance with an aspect of the present invention.

FIG. 9 is a flowchart of a method of an LLL reduction with joint sorting and reduction in accordance with an aspect of the present invention.

FIG. 10 is a flowchart of a method of truncated LLL reduction with joint sorting and reduction in accordance with another aspect of the present invention.

FIG. 11 is a block diagram representing an exemplary non-limiting computing system in which the claimed subject matter can be implemented.

FIG. 12 is a diagram of a network environment in which the claimed subject matter can be implemented.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

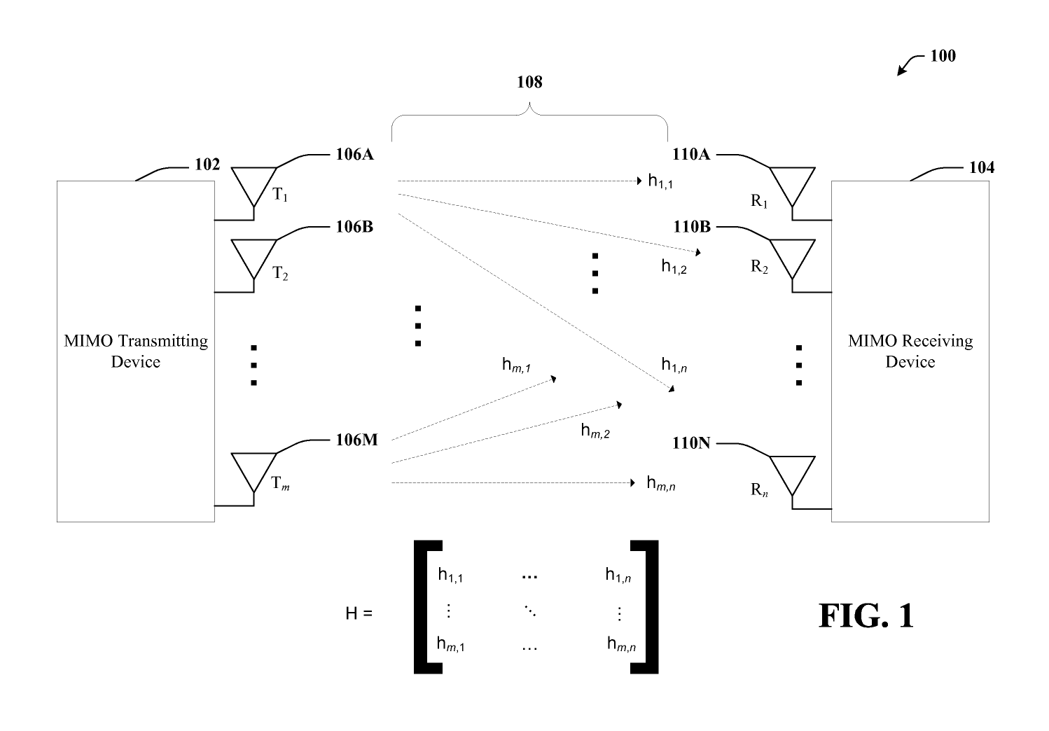

Turning to FIG. 1, an exemplary operating environment 100 is illustrated. In particular, a MIMO transmitting device 102 and a MIMO receiving device 104 are illustrated. The MIMO transmitting device 102 has m transmitting antennas (106A, 106B . . . 106M). Each transmitting antenna send data over channel 108 to n receiving antennas. For the sake of clarity, it is assumed that m<=n. A channel matrix H is formed based on the transmission with the transmitting antenna corresponding to the row in the channel matrix and the receiving antenna corresponding to the column. Although for the sake of clarity the MIMO receiver and MIMO transmitter (and their associated antennas) are illustrated and described as receiving transmissions and transmitting transmissions, one skilled the art will appreciate that a single device with an array of antennas can acts as both a MIMO receiver 104 and a MIMO transmitter 102.

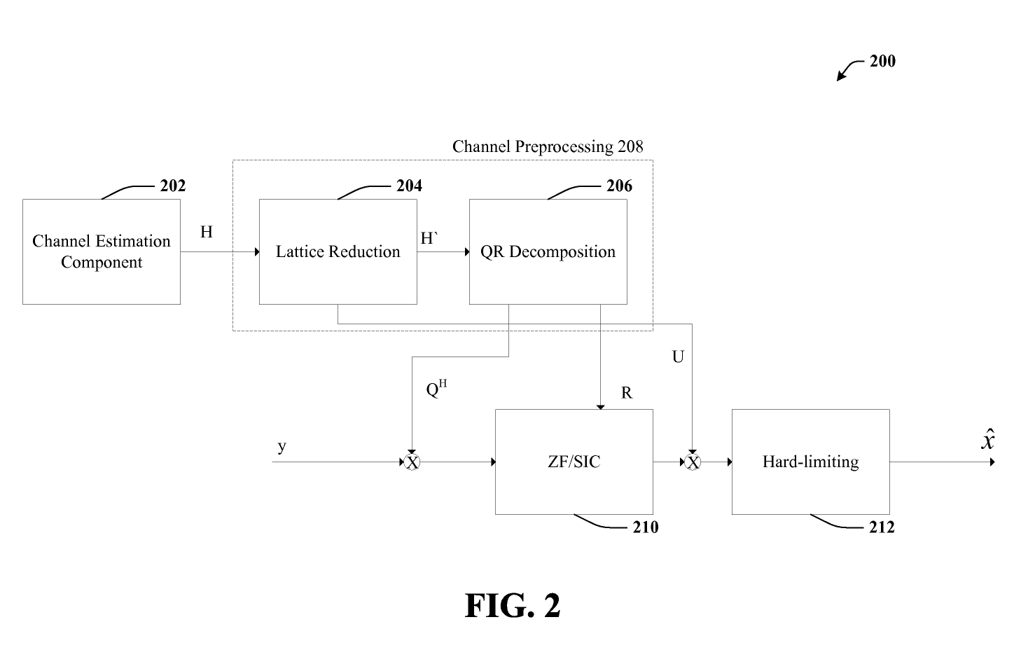

FIG. 2 illustrate data flow in a MIMO receiver. The channel estimation component 202 receives the signal via the receiving antennas 110 and determines a channel matrix corresponding to at least one channel. The channel matrix H is input into the lattice reduction component 204 where the Lenstra-Lenstra-Lovász (LLL) lattice reduction and techniques discussed herein occur. The QR decomposition component uses the H′ to produce Q^{H} and R. The QR decomposition component and the lattice reduction component perform the channel preprocessing 208. A zero-forcing (ZF) or a successive interference cancellation (SIC) decoder component is then used to facilitate decoding of the transmitted symbols. Finally, the hard-limiting component outputs what it thinks the transmitted symbols were.

The LLL reduction is a popular technique for lattice reduction (e.g., in the lattice reduction component 204) since it runs in polynomial time. However, since the traditional LLL reduction algorithm is a theoretical number tool, it works on real lattices, not complex lattices. Consequently, the real-valued equivalent matrix of the complex channel matrix H is often used instead of the complex matrix:

$${H}_{R} [ \begin{matrix} ( H ) & - ( H ) \\ ( H ) & ( H )\end{matrix} ] \qquad ( Equation 1 )$$

where [symbol] (H) denotes the matrix comprising the real part of matrix H and ℑ(H) denotes the matrix comprising the imaginary part of matrix H. The complex MIMO system model is replaced by its real equivalent model

y_{R}=H_{R}x_{R}+w_{R}, (Equation 2)

where y_{R}=[ [symbol] (y) [symbol] (y)]^{T} and similarly for x_{R} and W_{R}.

The direct application of LLL reduction using the real-valued equivalent matrix doubles the channel matrix dimension and adds unnecessarily complexity to lattice reduction. Moreover, since the reduced basis matrix does not generally have the matrix structure as in Equation 1, the detection part also has to be done in the real number field, rather than its natural complex number field.

Accordingly, a complex LLL (CLLL) reduction technique is provided that use the same the steps of the traditional LLL technique. Namely,

GSO procedure: a GSO procedure to compute Hᵢ

Size reduction: A process that aims to make basis vectors shorter and closer to orthogonal.

Basis vectors swapping: Two consecutive basis vectors hₖ₋₁ and hₖ will be swapped if Hₖ≧(δ−|μ_{k,k-1}|²)Hₖ₋₁ is violated. Thus, after swapping, size reduction can be repeated to make the basis vectors shorter.

The two steps, size reduction and basis vectors swapping, iterate until Hₖ≧(δ−|μ_{k,k-1}|²)Hₖ₋₁ is satisfied by all pairs of hₖ₋₁ and hₖ. The resultant basis is thus LLL-reduced.

Although a more generalized version of LLL algorithm already exists, several modifications are made such that a simple condition checking can be employed and the technique made even faster. From analytic and simulation results, the average overall complexity of the CLLL reduction algorithm can be about half of that of the real LLL (RLLL) reduction algorithm. The linear detectors employing CLLL reduced basis can achieve full diversity just like RLLL. Finally, simulation results reveal that the bit-error-rate performance of CLLL-aided schemes are virtually the same as RLLL-aided schemes.

The GSO procedure can be extended to complex vectors. Moreover, since μ_{i,j} is now complex, the modified size reduction condition is:

| [symbol] (μ_{i,j})|≦0.5 and | [symbol] (μ_{i,j})|≦0.5 (Equation 3)

for 1≦j<i≦n. The swapping condition remains unchanged, but factor δ is now restricted to ½<δ<1 for convergence and polynomial running time.

The complexity of the LLL reduction algorithm depends on the distribution of the random basis matrix H. For real lattices, the complexity of RLLL is

$$O ( {n}^{3} m log \frac{B \sqrt{n}}{λ ( {Λ}_{R} )} )$$

where B_{R} is the norm of the longest column vector of H_{R}, λ(Λ_{R}) denotes the norm of the shortest vector in lattice Λ_{R} generated by H_{R}. The result is expanded to complex lattices.

Theorem 1 Consider an m×n complex matrix H=[h₁ . . . hₙ] that generates an n-dimensional complex lattice Λ. The complexity of the CLLL algorithm on basis H is

$$O ( {n}^{3} m log \frac{B \sqrt{n}}{λ ( {Λ}_{R} )} ) ,$$

where B is the norm of the longest column vector of H, and λ(Λ_{R}) is the norm of the shortest vector in complex lattice Λ generated by H.

To preliminarily estimate how much complexity can be reduced by applying CLLL, compared with RLLL, the CLLL-to-RLLL Complexity Ratio is considered

$$K \frac{{n}^{2} {P}_{c} ( n ) mn log \frac{B \sqrt{n}}{λ ( Λ )}}{4 {n}^{2} {P}_{r} ( 2 n ) ( 4 mn ) log \frac{{B}_{R} \sqrt{2 n}}{λ ( {Λ}_{g} )}} \qquad ( Equation 4 )$$

where K is an architecture-dependent factor, meaning, on average, how many real arithmetic operations have to be executed per each complex operation. For example, if a complex addition uses 2 real arithmetic operations and a complex multiplication uses 6, then K=(6+2)/2=4 since the number of additions and multiplications are roughly the same for CLLL and RLLL. Pc (Pr) denotes the probability that the conditional test is passed in CLLL (RLLL), i.e.

Pᵣ(2n)=P{|μ_{i,j}(2n)|>0.5}, μ_{i,j}|real (Equation 5)

and

P_{c}(n)=P{ [symbol] [|μ_{i,j}(n)|]>0.5 or [symbol] [|μ_{i,j}(n)|]>0.5}, (Equation 6)

where, for clarity, the dependence on the dimension is shown explicitly.

TABLE 1
Probability that the size reduction conditional test is passed in CLLL
(Pc) and RLLL (Pr).

| n | Pc(n) | Pr(2n) | c/r |
|---|---|---|---|
| 4 | 0.5232 | 0.2214 | 2.3635 |
| 6 | 0.4401 | 0.1890 | 2.3288 |
| 8 | 0.3953 | 0.1755 | 2.2524 |
| 10 | 0.2898 | 0.1228 | 2.3604 |
| 12 | 0.2686 | 0.1185 | 2.2661 |
| 14 | 0.2463 | 0.1128 | 2.1839 |
| 16 | 0.2284 | 0.1076 | 2.1225 |
| 18 | 0.2103 | 0.1020 | 2.0606 |
| 20 | 0.1944 | 0.0962 | 2.0220 |
| 22 | 0.1782 | 0.0898 | 1.9839 |

By definition of μ_{i,j} the random variables [symbol] [μ_{i,j}(n)], [symbol] [μ_{i,j}(n)] and real-valued μ_{i,j} (2n) should have similar statistics. Moreover, as shown in Table 1 for n≦22, empirical results suggest that the reasonable assumption is made that for circular symmetric complex Gaussian H, the events | [symbol] [μ_{i,j}(n)]|>0.5 and | [symbol] [μ_{i,j}(n)]|>0.5 are statistically independent. As supported by the empirical result shown in Table 1,

$$\begin{matrix}{P}_{c} ( n ) \approx P \{ \vert [ {μ}_{k , k - 1} ( n ) ] \vert > 0.5 \} + \\ P \{ \vert [ {μ}_{k , k - 1} ( n ) ] \vert > 0.5 \} \\ = 2 P \{ \vert [ {μ}_{k , k - 1} ( n ) ] \vert > 0.5 \} \\ = 2 {P}_{r} ( 2 n )\end{matrix} \qquad ( Equation 7 )$$

$$\frac{B \sqrt{n}}{λ ( Λ )} / log \frac{{B}_{R} \sqrt{2 n}}{λ ( {Λ}_{R} )} -> 1$$

With this information and the fact that log for large enough n, the ratio in Equation 4 becomes

CRCR=K/16×2=K/8=½ (Equation 8)

where the common value 1=4 was used. This means that CLLL algorithm will have half of the complexity of RLLL algorithm. Empirical results confirm the above prediction of 50% complexity reduction.

The upper bounds for traditional RLLL are valid for CLLL-reduced basis

$$α = \frac{2}{2 δ - 1}$$

as well, except that in this case. Hence lattice-reduction-aided detection schemes utilizing CLLL reduction can also achieve full diversity, just like the traditional LLL.

The average complexity and the error-rate performance is compared when the reduced bases were used in MIMO detection.

The average complexity was measured in terms of the average number of floating-point operations (flops) used. Simulations were conducted in which the number of flops for complex addition equals 2 and the number of flops for complex multiplication equals 6. For real numbers, both addition and multiplication occur in 1 flop. Moreover, it is assumed the costs of rounding and hard-limiting are negligible when compared to floating-point addition and multiplication. The LLL factor δ was set to 0.99 in all cases for the best performance.

The average complexity of LLL-reduction-aided successive interference cancellation (LLL-SIC) detection scheme was determined. The whole detection process can be divided into two parts: preprocessing and processing. The preprocessing part includes these operations:

Lattice reduction of channel matrix H.

QR decomposition of the reduced channel matrix H′.

And the processing part includes:

Matrix multiplication Q^{Hl}y.

TABLE 2
Average complexity in flops, assuming flops per complex addition and 6 flops
per complex multiplication

| | | | | QR decomposition: | | | |
|---|---|---|---|---|---|---|---|
| | Lattice reduction | | | QR ← H′QR | | | Overall % |
| n | RLLL | CLLL | % reduced | Real | Complex | % reduced | reduced |
| 2 | 275.29 | 145.05 | 47.3% | 273 | 156 | 42.9% | 45.1% |
| 3 | 979.14 | 546.00 | 44.2% | 845 | 504 | 40.4% | 42.4% |
| 4 | 2370.75 | 1351.56 | 43.0% | 1897 | 1116 | 41.2% | 42.2% |
| 6 | 8484.71 | 4787.58 | 43.6% | 6017 | 3420 | 43.2% | 43.4% |
| 8 | 21038.71 | 11557.68 | 45.1% | 13785 | 7644 | 44.6% | 44.9% |
| 10 | 42415.11 | 22524.70 | 46.9% | 26353 | 14364 | 45.5% | 46.4% |
| 12 | 73976.54 | 38387.97 | 48.1% | 44873 | 24156 | 46.2% | 47.4% |
| 14 | 118243.35 | 59788.66 | 49.4% | 70497 | 37596 | 46.8% | 48.4% |
| 16 | 176326.09 | 87264.24 | 50.5% | 104377 | 55260 | 47.1% | 49.2% |

Successive interference cancellation and detection.

Unimodular transformation U\hat{x}′, where \hat{x} is the vector obtained by successive nulling and cancellation; and hard-limiting of the resultant vector to a valid modulation symbol vector.

Table 2 illustrates the average complexity of the preprocessing and processing part of LLL-SIC. Since the complex lattice was manipulated rather than the real-equivalent lattice, the complexity of the entire preprocessing part was reduced by 45.1% for m=n=2 (i.e. a 2-transmitter-2-receiver system), and reduced by somewhere between 42.4% to 49.2% for larger n.

In particular, the complexity reduction of the CLLL reduction algorithm over the traditional RLLL is about 44.2% to 50.5% for the selected range of n.

About 40.4% to 47.1% of the computation was reduced by computing QR decomposition in the complex number field. If it is assumed that the number of complex additions is roughly the same as the number of complex multiplications for this part, 4 flops are used for each complex number operation on average. Thus, the complexity reduction of this part approaches 4/8=50% for sufficiently large n.

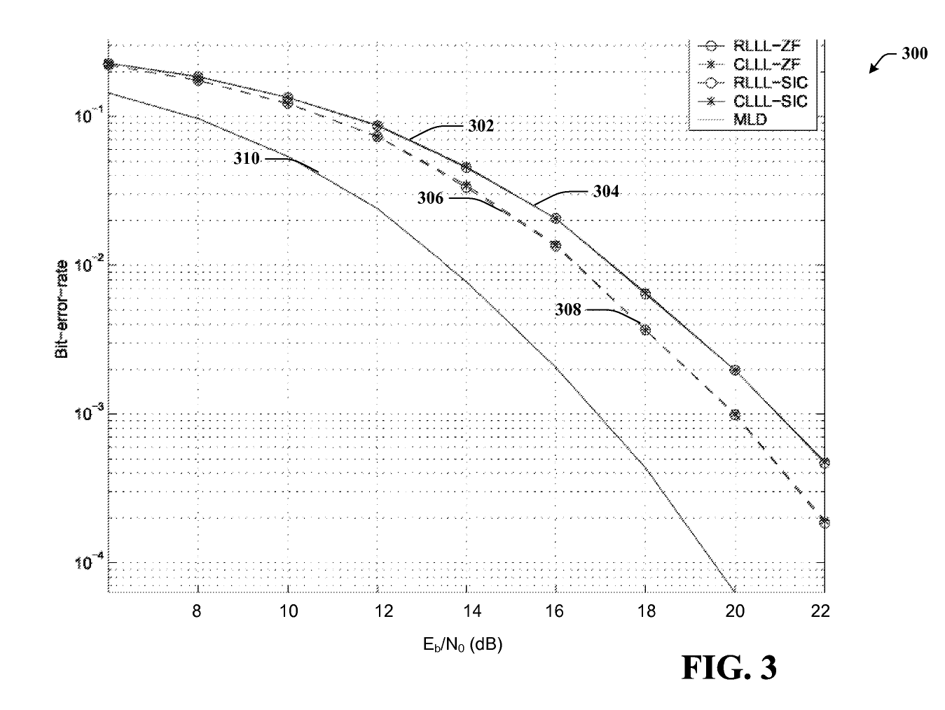

The bit-error-rate (BER) performance when traditional RLLL-reduced and CLLL-reduced basis are used in MIMO detection are shown in FIG. 3. The MIMO systems under consideration are 4×4 using 16-QAM. The lattice-reduction-aided detection schemes being examined are SIC and ZF. As a comparison, the performance of ML detection (MLD) are also shown.

To prove that the LLL reduction algorithm will be terminated in polynomial time, a positive-valued quantity

$$D {=}^{Δ} {\prod }_{i = 1}^{n} {‖ {h}_{i}^{*} ‖}^{2 ( n - 1 )} = {\prod }_{i = 1}^{n} {\prod }_{j = 1}^{i} {H}_{j} \qquad ( Equation 9 )$$

is defined. The value is reduced by a factor of at least 1/δ after each basis vector swapping in the LLL algorithm. Since there is a lower bound on this value for a given lattice, the algorithm terminates after a finite number of steps.

The first step of the LLL algorithm is the execution of the GSO process. Different permutations of the original vectors produce different set of orthogonal vectors, and hence different values of Equation 9. Therefore, some permutations give smaller initial values of Equation 9. The complexity of LLL algorithm can be further reduced by sorting the vectors such that D is minimized.

One technique to can reduce Equation 9 is to sort the basis vectors in ascending order according to their norm. More precisely, let π be the permutation of basis vectors, then

πᵢ=arg_{j≠π}_{_{k<i}}min∥hⱼ∥. (Equation 10)

This ordering is called norm-induced ordering. Although it takes time to calculate Equation 10, simulation results show that this simple scheme is enough to reduce the complexity of LLL.

The original V-BLAST detection algorithm sorts the basis vectors implicitly. This suggests the idea of employing such ordering to reduce the complexity of LLL. Geometrically speaking, to choose the next vector to be reduced, each of the candidate vectors is projected on to the orthogonal complement of the subspace spanned by the other candidate vectors in [symbol] ⁿ, and the one with shortest projection.

However, the cost of computing V-BLAST is indeed quite high and not offset by the complexity reduction obtained. Accordingly, the scheme is not very attractive. Nonetheless, if this ordering is known a priori, for example from V-BLAST detection of previous symbol, then this information can be used to reduce largely the complexity of LLL.

This modified QR decomposition algorithm aims to maximize the diagonal elements of the R matrix (i.e. the upper triangular matrix) using a greedy approach, i.e. R_{n,n} is maximized, and then R_{n-1,n-1}, R_{n-2,n-2} and so on. A small modification convert it into GSO algorithm that aims to minimize the norm of the orthogonal vectors h*'s.

Although sorted-QR ordering does not produce better ordering than the V-BLAST ordering, sorted-QR ordering can achieve greater overall complexity reduction than V-BLAST ordering because the sorting is performed implicitly in the GSO procedure.

A novel technique jointly performs vector sorting stage and lattice reduction stage.

The traditional LLL reduction works in a successive manner. In other words, to LLL-reduce a basis consisting of vectors {h₁, . . . , hₙ}, the algorithm reduces {h₁, h₂} first, which is called the first reduction step. After that, the algorithm goes on to reduce {h′₁, h′₂, h′₃} where h′₁, h′₂ denote the reduced basis vectors obtained in the first reduction step, and so on. After n−1 reduction steps, the whole basis is reduced.

Now, after the i-th reduction step, instead of picking hᵢ₊₁ as the next vector to be reduced, a vector is picked among the candidate vectors hᵢ₊₁, . . . hₙ that would minimize or reduce the overall complexity. In other words, a candidate vector is labeled as hᵢ₊₁ after the i-th reduction step if, by doing so, the overall complexity can be reduced according to some heuristics. This approach is called joint sorting and reduction (JSAR) as the processes of LLL reduction and vector sorting are now jointly considered.

Note how this approach is different from naive sorting discussed supra. In the JSAR approach, the (i+1)-th vector to be reduced is not determined until the i-th reduction step is completed. As some vectors may have been manipulated in the last reduction step, the best candidate to be labeled hᵢ₊₁ may inevitably be changed too. In contrast, in the naive sorting approach, the ordering is fixed after starting the reduction. In general, a better result can be expected with this joint approach.

A heuristic for JSAR is provided that can reduce the overall complexity of the LLL reduction technique.

Denote B as the set of candidate vectors. All vectors are projected in B to the orthogonal complement of the space spanned by the labeled vectors, and pick the one with the shortest projection. For the first one, the basis vector selected is the one with the smallest norm. More precisely,

hᵢ=arg_{νεB}min∥proj(νSᵢ₋₁^{⊥})∥ (Equation 11)

where Sᵢ₋₁^{⊥} denotes the orthogonal complement of Sᵢ₋₁ [symbol] span (h₁, . . . hᵢ₋₁) in [symbol] ⁿ, and proj (ν, U^{⊥}) denotes the projection of vector v onto subspace U^{⊥}. This heuristic is called minimum projection ordering (MPO).

The complexity of computing Equation 11 seems to be huge. However, the GSO algorithm can be modified such that Equation 11 can be computed implicitly, similar to sorted-QR.

Unfortunately, this piece of information comes with a small price. Assume that the first p basis vectors are to be LLL-reduced, and during the reduction hₖ₋₁ and hₖ were swapped. After the swapping, these need updating:

$$[ \begin{matrix}{μ}_{k - 1 , 1} & ⋯ & {μ}_{k - 1 , k - 1} & \\ {μ}_{k , 1} & ⋯ & {μ}_{k , k - 1} & {μ}_{k , k} \\ & & ⋮ & ⋮ \\ & & {μ}_{p ; k - 1} & {μ}_{p , k} \\ & & {μ}_{p + 1 , k - 1} & {μ}_{p + 1 , k} \\ & & {μ}_{p + 2 , k - 1} & {μ}_{p + 2 , k}\end{matrix} ] \qquad ( Equation 12 )$$

With the traditional GSO, μ_{p+1,k-1}, μ_{p+1,k′}, μ_{p+2,k-1} and μ_{p+2,k} do not need to be updated, since they were not even computed at this stage (only μ_{i,j}′s for j≦i≦p had been computed). However, the μ_{i,j}'s are now determined in this ordering. μ_{1,1}, μ_{2,1}, . . . μ_{n,1}, μ_{2,2} . . . μ_{2,n} . . . μ_{n,n} In particular the values in Equation 12 are now determined from top to bottom, left to right. Nonetheless, simulation results show that with minimum projection ordering, a saving in complexity can be obtained.

The ordering heuristic is very similar to sorted-QR. In fact, if the original basis was “good” enough, such that basis vector swapping never occurs, then the two ordering schemes coincide. However, when there is basis vector swapping, the sorted-QR ordering in naive sorting and minimum projection ordering in JSAC would produce different results.

The average complexity and the error-rate performance is compared when the reduced bases are used in MIMO detection. Advantageously, JSAR with minimum projection ordering achieves the largest complexity reduction among the sorting schemes. Hereinafter, LLL reduction algorithm with JSAR employing minimum projection ordering heuristic will be referred to as LLL-MPO.

The JSAR technique can be applied to the LLL reduction of real or complex lattice bases. To demonstrate that JSAR can be employed simultaneously with complex LLL reduction, the comparison were performed between CLLL and CLLL-MPO (i.e. complex LLL lattice reduction with JSAR).

Table 3 illustrates the average complexity of CLLL algorithm and the CLLL-MPO algorithm. The complexity, in terms of number of flops, was reduced by 11.85% when m=n=2 (i.e. a 2-transmitter-2-receiver system), and reduced by somewhere between 16.53% to 27.90% for larger n. Similarly, the joint sorting and reduction technique reduced the average number of basis vector swappings by 47.56% when n=2, and up to 60.35% when n=10.

TABLE 3
Average complexity of CLLL and CLLL-MPO. δ = 0.99

| | Average no. of flops | | | Average no. of swappings | | |
|---|---|---|---|---|---|---|
| | | CLLL- | | | CLLL- | |
| Dim. N | CLLL | MPO | % saved | CLLL | MPO | % saved |
| 2 | 143.83 | 126.79 | 11.85% | 0.80 | 0.42 | 47.56% |
| 3 | 561.90 | 469.02 | 16.53% | 2.56 | 1.35 | 47.49% |
| 4 | 1420.14 | 1149.40 | 19.06% | 5.37 | 2.80 | 47.88% |
| 5 | 2882.30 | 2277.20 | 21.00% | 9.13 | 4.65 | 49.03% |
| 6 | 5116.87 | 3961.39 | 22.58% | 13.78 | 6.82 | 50.48% |
| 8 | 12514.26 | 9321.16 | 25.52% | 25.12 | 11.29 | 55.07% |
| 10 | 24589.51 | 17729.04 | 27.90% | 37.82 | 14.99 | 60.35% |

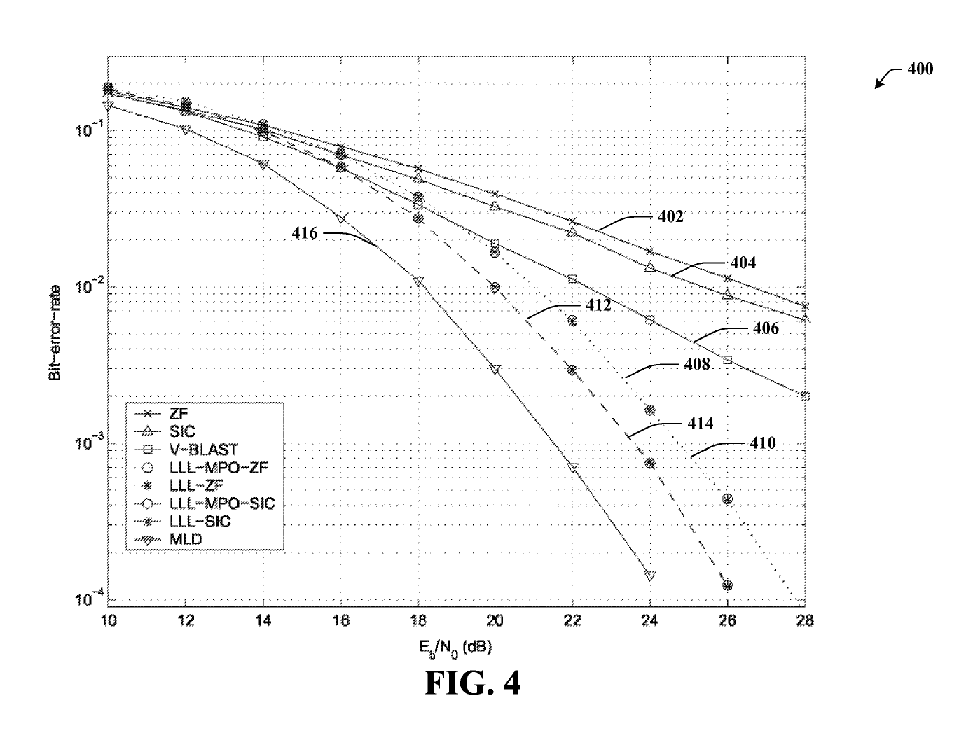

The bit-error-rate (BER) performances are shown in FIG. 4. LLL-reduced bases, which are produced by the traditional algorithm and the sorted LLL algorithm, are used in MIMO detection. The MIMO system under consideration is a 4×4 uncoded system using 64-QAM. The lattice-reduction-aided detection schemes are SIC and ZF. As a comparison, the performance of ZF, SIC, V-BLAST and MLD detectors are also shown.

FIG. 4 illustrates that both algorithms result in practically identical BER performance in MIMO detection. In particular, FIG. 4 illustrates curves for ZF 402, SIC 404, V-BLAST 406, LLL-MPO-ZF 408, LLL-ZF 410, LLL-MPO-SIC 412, LLL-SIC 414, and maximum likelihood detection (MLD) 416. Since sorting does not alter the definition of LLL reduction, the resultant bases enjoy the same properties as the traditional LLL algorithm. Thus, the technique reduces the complexity of lattice reduction without sacrificing the performance.

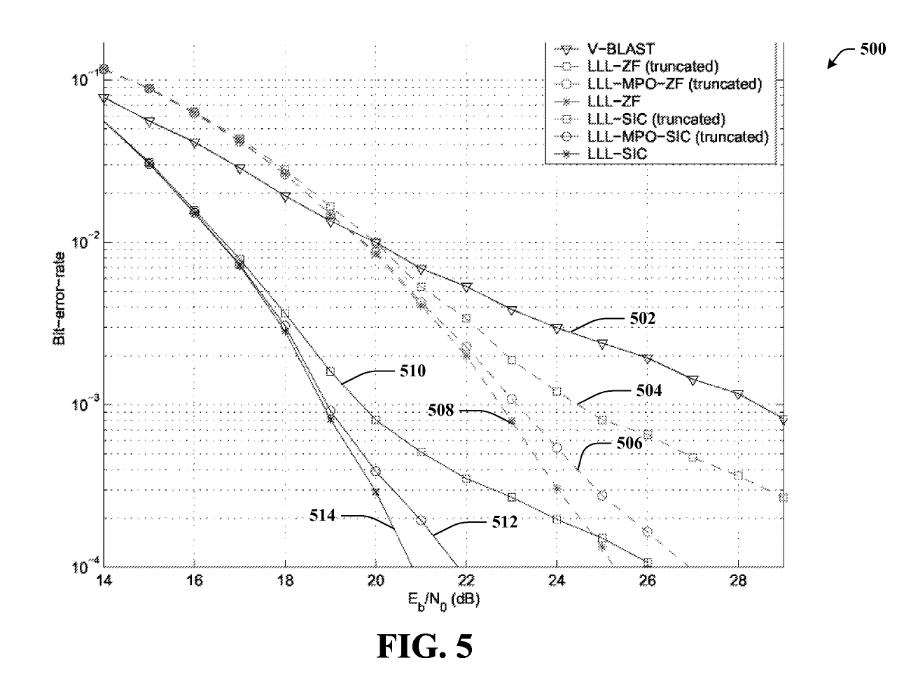

In some scenarios, the fully reduced lattice for the channel basis is not desirable, such as due to a maximum delay-constraint. In such case, the lattice reduction process can be stopped once the delay is over a certain threshold. This method is called a truncated LLL reduction. FIG. 5 illustrates the BER performance of the non-truncated algorithm (represented by curves 508, 514) and the truncated algorithm (represented by curves 504,506 for LLL-ZF and curves 510, 512 for LLL-SIC) when the number of basis vector swapping is limited to 50, in an 8×8, 16-QAM MIMO system. At BER=5×10⁻⁴, the performance of the truncated algorithm has less than 0.5 dB degradation compared to the full CLLL reduction, while the traditional algorithm is nearly 2.5 dB worse for LLL-ZF and 2 dB worse for CLLL-SIC. Moreover, the truncated algorithm has higher diversity order in both cases; however, neither the traditional LLL algorithm nor the truncated CLLL has full diversity since the upper bounds no longer apply to partial reduced basis.

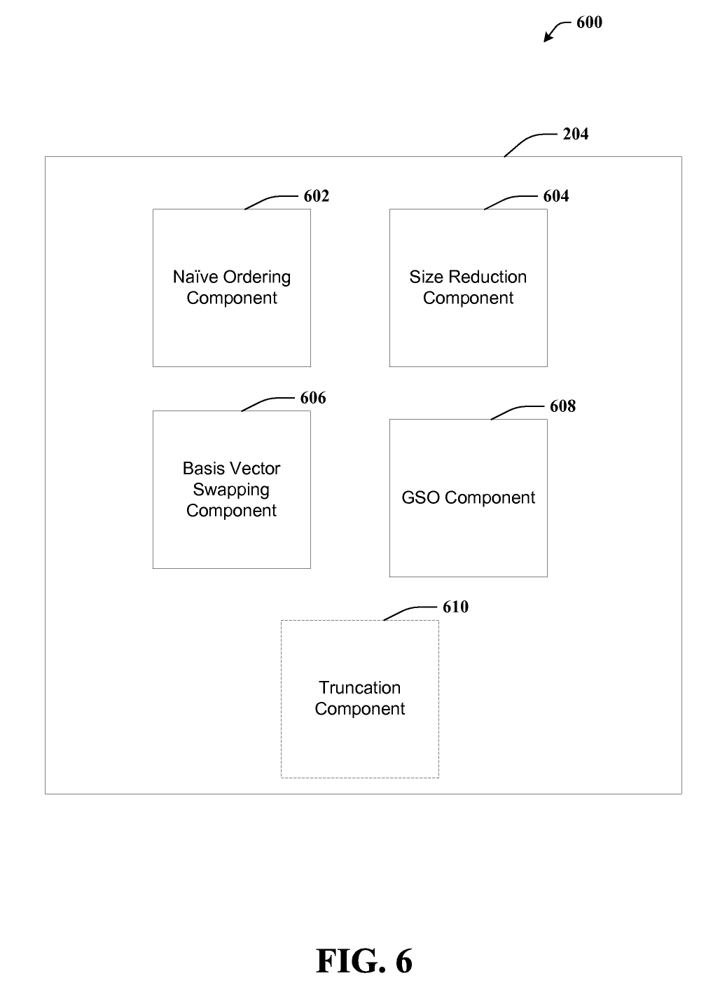

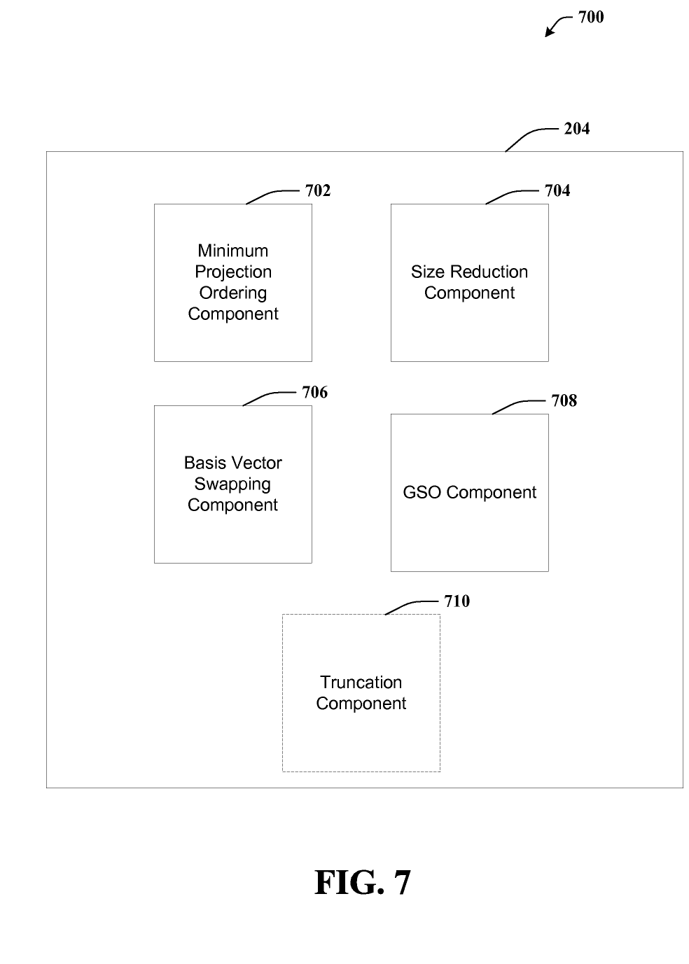

FIGS. 6 and 7 each illustrate components of a lattice reduction component 202 according to one embodiment. For the sake of clarity, other hardware or software components traditionally associated with a MIMO receiver (e.g., receiving antennas, components described in connection with FIG. 2) are not shown and described. However, one skilled in the art will appreciate that these additional hardware or software components can be present.

FIG. 6 illustrates a lattice reduction component 204 according to one embodiment. The naïve ordering component orders basis vectors according to either V-BLAST or sorted-QR ordering. The GSO component 608 is then used to perform the Gram-Schmidt Orthogonalization (GSO) to the sorted vectors. The output goes to the size reduction component 604 and basis vector swapping component 606 to perform the reduction iteration steps of complex LLL lattice reduction. The optional truncation component 610 can stop the LLL algorithm before the next iteration when a predetermined condition occurs, such as a predetermined number of iterations. The truncation component can utilize various subcomponent to measure and track if a predetermined condition does occur.

FIG. 7 illustrates a lattice reduction component 204 according to another embodiment. A minimum projection ordering component 702 can pick the vector with shortest projection as the next vector to reduce. The GSO component 708 is then used to perform the Gram-Schmidt Orthogonalization (GSO) to the sorted vectors. The output goes to the size reduction component 704 and basis vector swapping component 706 to perform the reduction iteration steps of complex LLL lattice reduction. An optional truncation component 710 can end the LLL reduction after a reduction step if predetermined conditions are met.

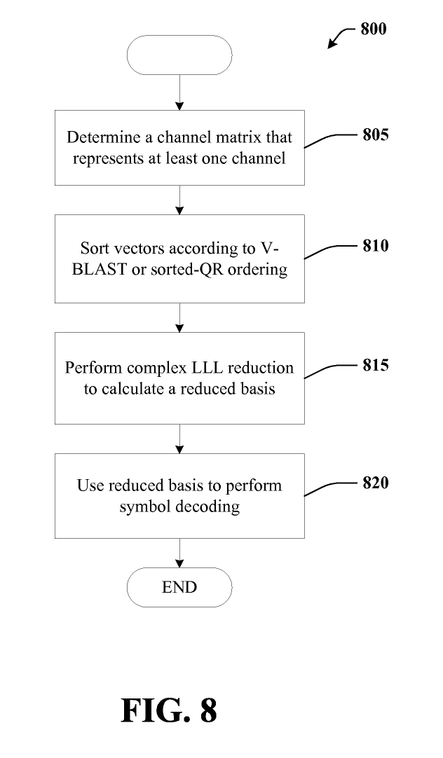

Turning briefly to FIGS. 8-10, methodologies that may be implemented in accordance with the present invention are illustrated. While, for purposes of simplicity of explanation, the methodologies are shown and described as a series of blocks, it is to be understood and appreciated that the present invention is not limited by the order of the blocks, as some blocks may, in accordance with the present invention, occur in different orders and/or concurrently with other blocks from that shown and described herein. Moreover, not all illustrated blocks may be required to implement the methodologies in accordance with the present invention. Furthermore, although for the sake of clarity, the methods are shown for a single decoding of received data, one will appreciate that these methods can be performed continuously.

FIG. 8 illustrates a method 800 of symbol decoding using complex LLL reduction according to one embodiment. At 805, a channel matrix is determined corresponding to at least one channel. This determination can be made, for example, by the channel estimation component 202 of FIG. 2. At 810, the basis vectors that comprise the determined channel matrix are sorted according to V-BLAST or sorted-QR ordering. Other orderings, well-known in the art, can also be alternatively used. At 815, complex LLL reduction is used to calculate a reduced basis. At 820, the reduced basis is used to perform symbol decoding, such as using a ZF or SIC decoder.

Although not shown, the method can be truncated after multiple iterations when a predetermined condition occurs, such as a predetermined amount of time has elapsed or a predetermined number of iterations have occurred.

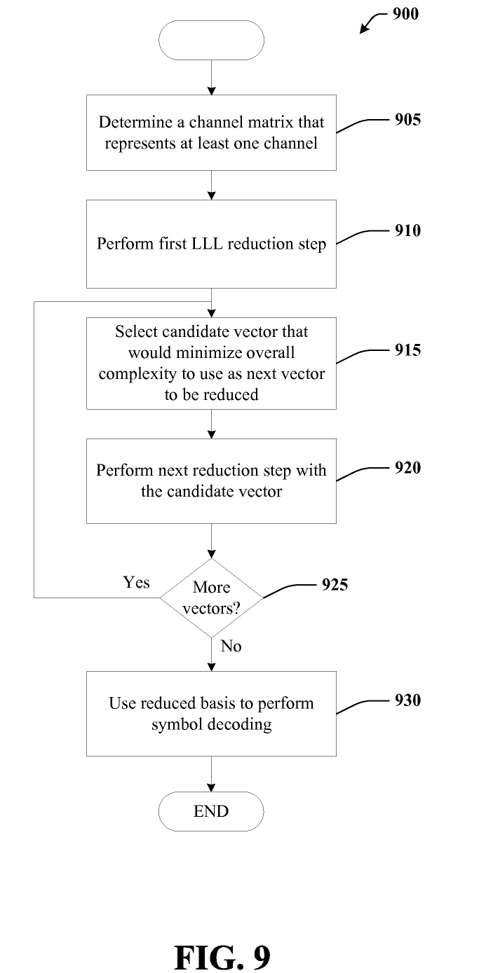

FIG. 9 illustrates a method 900 of an LLL reduction with joint sorting and reduction according to one embodiment. At 905, a channel matrix is determined, such as by the channel estimation component 202 of FIG. 2. Although not shown, the basis vectors can be pre-sorted in various manners (e.g., sorted-QR ordering) between 905 and 910 in order to increase the likelihood that the basis vectors are already in the optimal order so that new u_{i,j} values do not need to calculated. At 910, the first LLL reduction step is performed. At 915, the candidate vector that would minimize the overall complexity is selected as the next vector to be reduced. The selection can be, for example, based on the vector with the shortest projection. At 920, the next LLL reduction step is performed. At 925, it is determined if there are any more remaining vectors to reduce. If so, the method returns to 915 to select the next vector to reduce. If not, at 930, the reduced basis is used to perform symbol decoding, for example by using ZF or SIC.

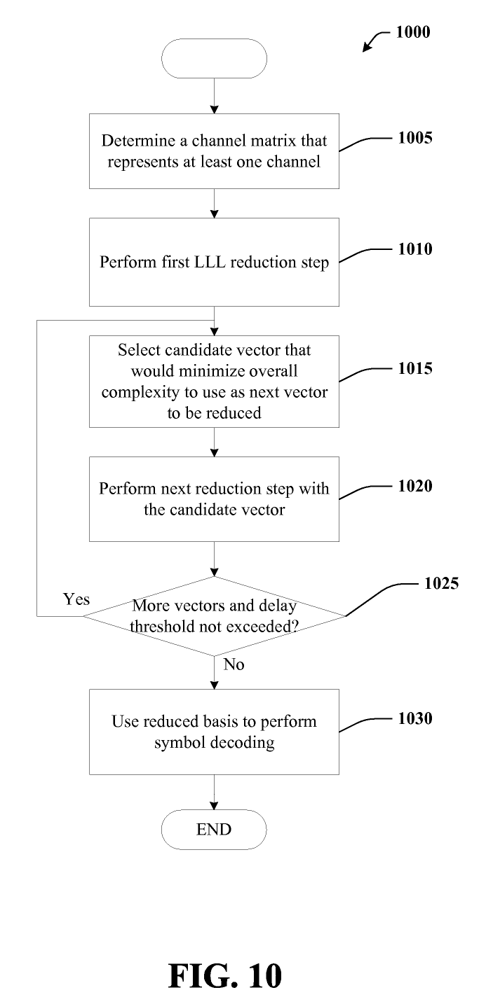

FIG. 10 illustrates a method 1000 of truncated LLL reduction with joint sorting and reduction according to one embodiment. At 1005, a channel matrix is determined, such as by the channel estimation component 202 of FIG. 2. Although not shown, the basis vectors can be pre-sorted in various manners (e.g., sorted-QR ordering) between 1005 and 1010 in order to increase the likelihood that the basis vectors are already in the optimal order so that new u_{i,j} values do not need to calculated. At 1010, the first LLL reduction step is performed. At 1015, the candidate vector that would minimize the overall complexity is selected as the next vector to be reduced. The selection can be, for example, based on the vector with the shortest projection. At 1020, the next LLL reduction step is performed. At 1025, it is determined if there are any more remaining vectors and the delay threshold not met. If so, the method returns to 1015 to select the next vector to reduce. If not, at 1030, the reduced basis is used to perform symbol decoding, for example by using ZF or SIC. Although this method illustrates, a delay threshold, other thresholds or events discussed supra could end future iterations of the LLL reduction steps.

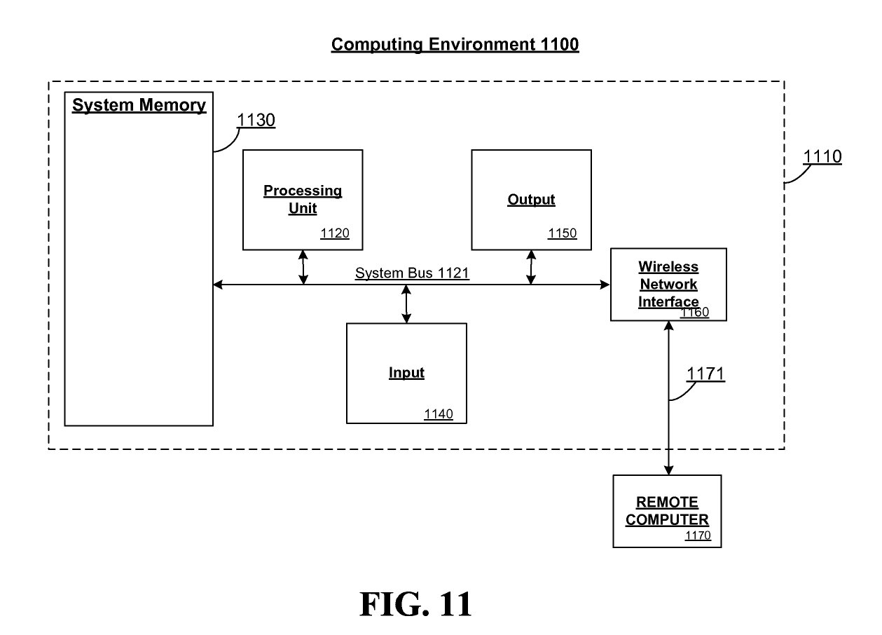

Turning to FIG. 11, an exemplary non-limiting computing system or operating environment in which the present invention may be implemented is illustrated. One of ordinary skill in the art can appreciate that handheld, portable and other computing devices and computing objects of all kinds are contemplated for use in connection with the present invention, i.e., anywhere that a wireless communications system may be desirably. Accordingly, the computer described below in FIG. 11 is but one example of a computing system in which the present invention may be implemented.

Although not required, the invention can partly be implemented via software (e.g., firmware). Software may be described in the general context of computer-executable instructions, such as program modules, being executed by one or more computers.

FIG. 11 thus illustrates an example of a computing device in a wireless communication network. Those skilled in the art will appreciate that the invention may be practiced with any suitable computing system environment 1100 in which the invention may be implemented but the computing system environment 1100 is only one example of a suitable computing environment and is not intended to suggest any limitation as to the scope of use or functionality of the invention. Neither should the computing environment 1100 be interpreted as having any dependency or requirement relating to any one or combination of components illustrated in the exemplary operating environment 1100.

With reference to FIG. 11, an example of a computing device for implementing the invention includes a general purpose computing device in the form of a computer 1110. Components of computer 1110 may include, but are not limited to, a processing unit 1120, a system memory 1130, and a system bus 1121 that couples various system components including the system memory to the processing unit 1120. The system bus 1121 may be any of several types of bus structures including a memory bus or memory controller, a peripheral bus, and a local bus using any of a variety of bus architectures.

Computer 1110 typically includes a variety of computer readable media. Computer readable media can be any available media that can be accessed by computer 1110. By way of example, and not limitation, computer readable media may comprise computer storage media and communication media. Computer storage media includes volatile and nonvolatile as well as removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1110. Communication media typically embodies computer readable instructions, data structures, program modules or other data in a modulated data signal such as a carrier wave or other transport mechanism and includes any information delivery media.

The system memory 1130 may include computer storage media in the form of volatile and/or nonvolatile memory such as read only memory (ROM) and/or random access memory (RAM). A basic input/output system (BIOS), containing the basic routines that help to transfer information between elements within computer 1110, such as during start-up, may be stored in memory 1130. Memory 1130 typically also contains data and/or program modules that are immediately accessible to and/or presently being operated on by processing unit 1120. By way of example, and not limitation, memory 1130 may also include an operating system, application programs, other program modules, and program data.

The computer 1110 may also include other removable/non-removable, volatile/nonvolatile computer storage media. For example, computer 1110 could include a flash memory that reads from or writes to non-removable, nonvolatile media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, digital versatile disks, digital video tape, solid state RAM, solid state ROM and the like.

A user may enter commands and information into the computer 1110 through input devices. Input devices are often connected to the processing unit 1120 through user input 1140 and associated interface(s) that are coupled to the system bus 1121, but may be connected by other interface and bus structures, such as a parallel port, game port or a universal serial bus (USB). A graphics subsystem may also be connected to the system bus 1121. A monitor or other type of display device may also connected to the system bus 1121 via an interface, such as output interface 1150, which may in turn communicate with video memory. In addition to a monitor, computer 1110 may also include other peripheral output devices, which may be connected through output interface 1150.

The computer 1110 operates in a networked or distributed environment using logical connections to one or more other remote computers, such as remote computer 1170, which may in turn have capabilities different from device 1110. The logical connections depicted in FIG. 11 include a network 1171. The network 1171 can include both the wireless network described herein as well as other networks, such a local area network (LAN) or wide area network (WAN).

When used in a LAN networking environment, the computer 1110 is connected to the LAN through a network interface or adapter. When used in a WAN networking environment, the computer 1110 typically includes a communications component, such as a modem, or other means for establishing communications over the WAN, such as the Internet. A communications component, such as a network interface card, which may be internal or external, may be connected to the system bus 1121 via the user input interface of input 1140, or other appropriate mechanism. In a networked environment, program modules depicted relative to the computer 1110, or portions thereof, may be stored in a remote memory storage device.

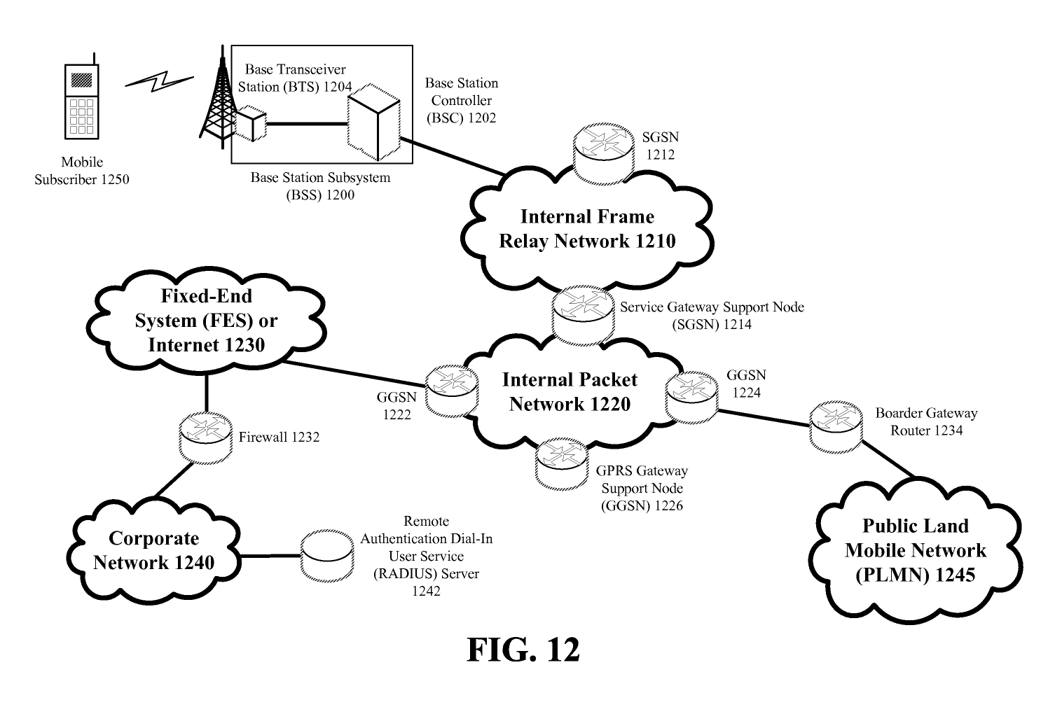

Turning now to FIG. 12, an overview of a network environment in which the claimed subject matter can be implemented is illustrated. The above-described systems and methodologies for signal detection in MIMO wireless networks may be applied to any wireless communication network; however, the following description sets forth an exemplary, non-limiting operating environment for said systems and methodologies. The below-described operating environment should be considered non-exhaustive, and thus the below-described network architecture is merely an example of a network architecture into which the claimed subject matter can be incorporated. It is to be appreciated that the claimed subject matter can be incorporated into any now existing or future alternative architectures for communication networks as well. For example, the descried signal detection can be done for wireless LANs that use MIMO technology.

FIG. 12 depicts an overall block diagram of an exemplary network environment that the MIMO wireless network may be a part of. Such an environment can include a plurality of Base Station Subsystems (BSS) 1200 (only one is shown), each of which can comprise a Base Station Controller (BSC) 1202 serving one or more Base Transceiver Stations (BTS) such as BTS 1204. BTS 1204 can serve as an access point where mobile device with multiple antennas (e.g., mobile subscriber devices 1250) become connected to the MIMO-based wireless network.

In one example, packet traffic originating from mobile subscriber 1250 is transported over the air interface to a BTS 1204, and from the BTS 1204 to the BSC 1202. Base station subsystems, such as BSS 1200, can be a part of internal frame relay network 1210 that can include Service GPRS Support Nodes (“SGSN”) such as SGSN 1212 and 1214. Each SGSN is in turn connected to an internal packet network 1220 through which a SGSN 1212, 1214, etc., can route data packets to and from a plurality of gateway GPRS support nodes (GGSN) 1222, 1224, 1226, etc. As illustrated, SGSN 1214 and GGSNs 1222, 1224, and 1226 are part of internal packet network 1220. Gateway GPRS serving nodes 1222, 1224 and 1226 can provide an interface to external Internet Protocol (“IP”) networks such as Public Land Mobile Network (“PLMN”) 1245, corporate intranets 1240, or Fixed-End System (“FES”) or the public Internet 1230. As illustrated, subscriber corporate network 1240 can be connected to GGSN 1222 via firewall 1232; and PLMN 1245 can be connected to GGSN 1224 via boarder gateway router 1234. The Remote Authentication Dial-In User Service (“RADIUS”) server 1242 may also be used for caller authentication when a user of a mobile subscriber device 1250 calls corporate network 1240.

Generally, there can be four different cell sizes-macro, micro, pico, and umbrella cells. The coverage area of each cell is different in different environments. Macro cells can be regarded as cells where the base station antenna is installed in a mast or a building above average roof top level. Micro cells are cells whose antenna height is under average roof top level; they are typically used in urban areas. Pico cells are small cells having a diameter is a few dozen meters; they are mainly used indoors. On the other hand, umbrella cells are used to cover shadowed regions of smaller cells and fill in gaps in coverage between those cells.

The present invention has been described herein by way of examples. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Various implementations of the invention described herein may have aspects that are wholly in hardware, partly in hardware and partly in software, as well as in software. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device.

Furthermore, the invention may be described in the general context of computer-executable instructions, such as program modules, executed by one or more components. Generally, program modules include routines, programs, objects, data structures, etc. that perform particular tasks or implement particular abstract data types. Typically the functionality of the program modules may be combined or distributed as desired in various embodiments. Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

Additionally, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The terms “article of manufacture,” “computer program product” or similar terms, where used herein, are intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, according to various permutations and combinations of the foregoing. Sub-components can also be implemented as components communicatively coupled to other components rather than included within parent components, e.g., according to a hierarchical arrangement. Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

What is claimed is:

1. A computer-readable medium containing instructions that when executed perform a method comprising:
determining a channel matrix corresponding to a channel in a multiple-input multiple-output wireless network;
sorting basis vectors of the channel matrix; and
performing Lenstra-Lenstra-Lovász (LLL) lattice reduction on the sorted basis vectors to determine a reduced lattice basis.

2. The computer-readable medium of claim 1 wherein the sorting of the basis vectors includes V-BLAST ordering.

3. The computer-readable medium of claim 1 wherein the sorting of the basis vectors includes sorted-QR ordering.

4. The computer-readable medium of claim 1 wherein the method further comprises symbol decoding based on the determined reduced lattice basis.

5. The computer-readable medium of claim 1 wherein the determining of a channel matrix corresponding to a channel includes determining a complex channel matrix and the performing of the LLL lattice reduction includes performing LLL reduction on the complex channel matrix and not a real-valued equivalent matrix of the complex channel matrix.

6. A method of determining a lattice basis in a multiple-input multiple-output (MIMO) receiver, the method comprising:
determining a channel matrix that represents at least one channel in a MIMO network including the MIMO receiver, the matrix comprised of multiple basis vectors;
performing a first Lenstra-Lenstra-Lovász (LLL) reduction step;
for each subsequent LLL reduction step,
selecting a remaining vector to be used as the next vector to be reduced so as to minimize computational complexity of determining the lattice basis; and
performing the subsequent LLL reduction step.

7. The method of claim 6 wherein the selecting of a vector to be used as the next vector to be reduced comprises picking the vector with the shortest projection.

8. The method of claim 6 wherein the performing of the first LLL reduction step comprises performing the first LLL reduction step on a basis vector with the smallest norm.

9. The method of claim 6 wherein performing the first LLL reduction step comprises performing the first LLL reduction step on a complex channel matrix instead of a real-valued equivalent matrix of the complex channel matrix.

10. The method of claim 6 wherein the performing of subsequent LLL reduction step comprises swapping.

11. The method of claim 6 further comprising for each subsequent LLL reduction step, determining if a predetermined condition occurred and when the predetermined condition occurs, ending the determination of the lattice basis.

12. The method of claim 11 wherein the predetermined condition is at least one of a predetermined number of iterations have occurred or a predetermined amount of time has elapsed in performing the first and subsequent LLL reduction steps.

13. The method of claim 6 further comprising decoding the channel matrix using the determined lattice basis to determine the transmitted symbols.

14. The method of claim 6 further comprising sorting the basis vectors prior to performing the first LLL reduction step.

15. An electronic apparatus that decodes signals in a multiple-input multiple-output (MIMO) wireless network, the apparatus comprising:
a memory;
a plurality of receive antennas;
a channel estimation component that identifies a channel matrix corresponding to a communication channel, the channel matrix comprising multiple basis vectors to reduce; and
a lattice reduction component that analyzes the channel matrix and determines a reduced lattice basis using a Lenstra-Lenstra-Lovász (LLL) technique in which after each iteration of the LLL technique, a next vector to reduce is selected so as to minimize computational complexity of determining the reduced lattice basis.

16. The electronic apparatus of claim 15 wherein the lattice reduction component comprises a truncation component that stops the LLL technique after a predetermined condition is met.

17. The electronic apparatus of claim 16 wherein the predetermined condition is at least one of a predetermined number of or a predetermined amount of time has elapsed in the LLL technique.

18. The electronic apparatus of claim 15 further comprising a decoder component that uses the reduced lattice basis to determine the transmitted symbols.

19. The electronic apparatus of claim 18 wherein the channel estimation component identifies a complex channel matrix and the LLL technique is performed on the complex channel matrix and not a real-valued equivalent matrix of the complex channel matrix.

20. The electronic apparatus of claim 15 wherein the selected vector is the vector with the shortest projection.
